(19) United States
(12) Patent Application Publication
(10) Pub. No.: US 2026/0324620 A1
(43) Pub. Date: Oct. 22, 2026

(54) System and Method for AI-or Rule- Driven Wildlife Call Playback with Dynamic Sound and Sequence Variation

(71) Applicant: Liguo Zhao, Holland, OH (US)

(72) Inventor: Liguo Zhao, Holland, OH (US)

(73) Assignee: ICOtec, LLC, Holland, OH (US)

(21) Appl. No.: 19/180,148

(22) Filed: Apr. 16, 2025

(51) Int. Cl. A01M 31/00

(52) U.S. Cl. CPC A01M 31/004

(57) ABSTRACT

A game caller system enhanced by artificial intelligence to provide lifelike sound variation, improving efficacy and reducing habituation among target animals. The system features an AI-driven variation engine that applies constrained real-time pitch, duration, and EQ modulation to base wildlife calls, as well as sequence-level variations including order, timing, and call selection modifications. The AI model is trained on wildlife behavior patterns using constrained generative models to ensure biological realism while introducing sufficient variation to prevent habituation. The system includes a physical user interface with buttons mapped to predefined playback modes or specific call sequences, and may be controlled via a remote device.

### FIELD OF THE INVENTION

The present invention relates generally to electronic wildlife game callers, and more specifically to a system and method for generating natural-sounding variations in wildlife calls using artificial intelligence or rule-based methods, with playback triggered through a physical control interface for use in hunting, wildlife photography, or research.

### BACKGROUND OF THE INVENTION

Electronic game callers have become increasingly popular among hunters and wildlife observers as tools to attract various animal species. Traditional game callers typically play pre-recorded animal sounds through speakers to mimic mating calls, territorial calls, or distress signals. However, these conventional systems often suffer from a significant limitation: they play identical sounds with each activation, leading to a phenomenon known as habituation where animals become accustomed to and eventually ignore the artificial calls.

Existing game callers on the market offer various features including remote controls, multiple pre-recorded sounds, and programmable sequences. However, these systems generally lack sophisticated sound variation capabilities that would more accurately mimic the natural variations found in wildlife vocalizations. Animals in the wild rarely make identical calls in succession, with natural variations in pitch, duration, tone, and sequence patterns.

The present invention addresses these limitations by incorporating artificial intelligence or rule-based technology to generate realistic variations in wildlife calls, significantly reducing the habituation effect and improving the efficacy of electronic game callers for hunting and wildlife observation purposes.

### SUMMARY OF THE INVENTION

The present invention provides an artificial intelligence or rule-based method enhanced game caller system that generates realistic variations in wildlife sounds to reduce habituation in target animals. The system incorporates an AI-driven or rule-based variation engine that modifies sound characteristics and sequence patterns while maintaining biological realism.

In one embodiment, the system includes a game caller unit with a memory configured to store wildlife sound files, a variation engine that applies pitch, speed, tone, and sequence adjustments to individual sound files during playback, and a speaker system for outputting the modified sounds. The system also includes a control interface, which may be integrated within the unit or located in a separate remote-control device, configured to initiate playback via physical buttons.

The variation engine may implement either an artificial intelligence model trained on wildlife behavior patterns using constrained generative models such as DDSP (Differentiable Digital Signal Processing) or WaveNet, or a rule-based logic system, or a combination thereof. The AI model analyzes base wildlife calls and generates variations that maintain species-specific characteristics while introducing natural-sounding differences in each playback instance.

The system further includes a randomization engine that selects or modifies playback parameters either prior to or during playback, or selects from a pre-generated batch of approved variations. This ensures that no two call sequences are identical, closely mimicking the natural variation observed in wildlife.

### BRIEF DESCRIPTION OF THE DRAWINGS

FIG. 1 illustrates an example AI game caller system architecture, including a game caller unit and associated functional modules.

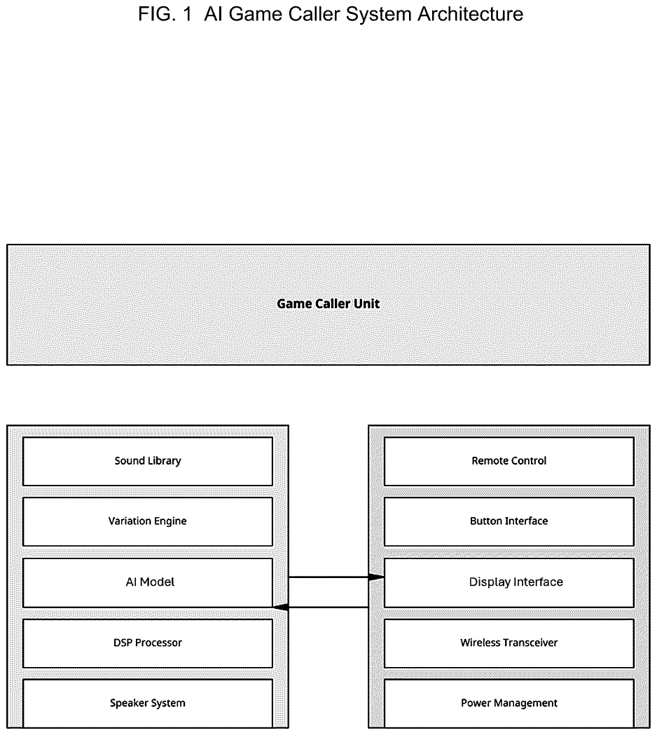

FIG. 2 illustrates an example flowchart for an AI-or rule-based variation engine configured to generate sound and sequence variations.

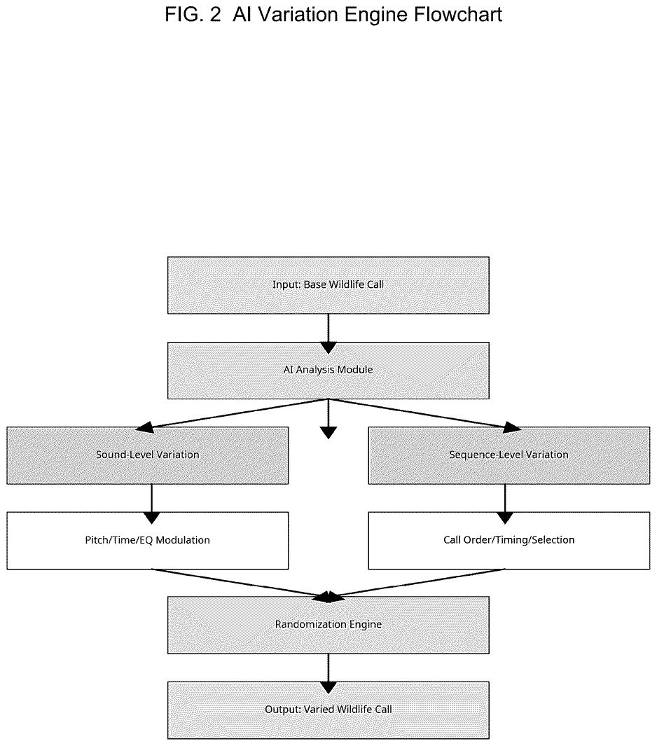

FIG. 3 illustrates example sound variation techniques applied to a base wildlife call, including pitch shifting, time stretching, and filtering.

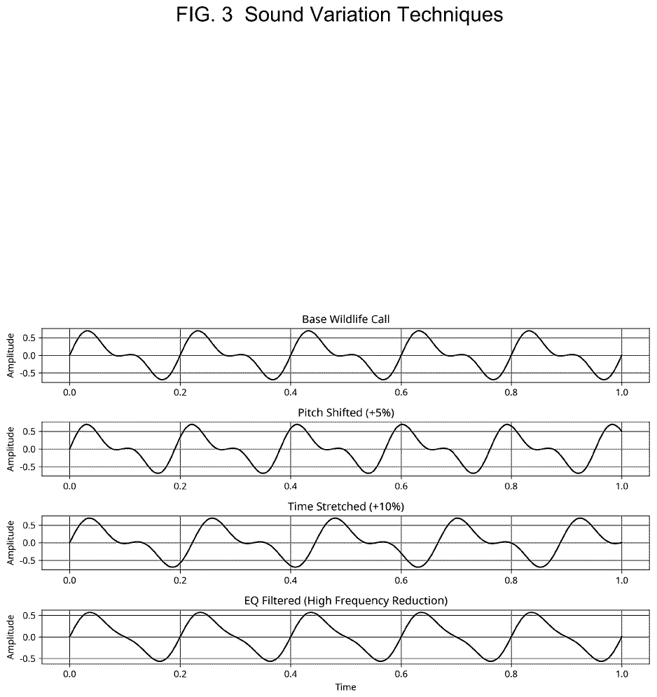

FIG. 4 illustrates example call sequence variation outputs produced from an original call sequence by modifying order, timing, and substitution.

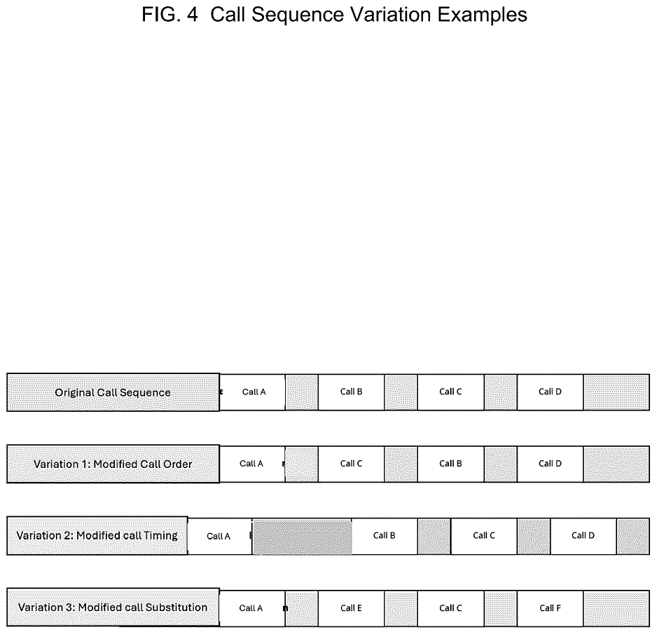

### DETAILED DESCRIPTION OF THE INVENTION

The system comprises:
1. A sound storage component that contains base animal calls or sequenced animal calls.
2. A variation engine, embedded in the game caller unit's firmware, capable of executing on a microcontroller or digital signal processor (DSP), and configured to perform:
   a. Pitch shifting within ±5% of base frequency
   b. Time stretching or compression within ±10% of original duration
   c. EQ filtering to simulate environmental or emotional variation
   d. Volume modulation to reflect perceived distance or urgency
   e. Sequence-level variation, including dynamic modification of the order, inclusion, timing, or substitution of calls within a call sequence
3. The variation engine may implement either an artificial intelligence model (e.g., trained on wildlife behavior patterns using constrained generative models such as DDSP or WaveNet) or a rule-based logic system, or a combination thereof.
4. A randomization engine that selects or modifies playback sound or call sequence parameters either prior to or during playback or selects from a pre-generated batch of approved variations.
5. A physical user interface either embedded in the unit or as part of a remote control with buttons mapped to predefined playback modes or specific call sequences. These buttons initiate playback sound or sequences that are subject to automatic variation at the sound or sequence level according to the system's internal logic, but do not alter the base selection of which call or sequence is initiated.

1. A wildlife game caller system comprising:
a game caller unit including:
(a) a memory configured to store a plurality of wildlife sound files;
(b) a sound variation engine configured to apply, including but not limited to, pitch, speed, and tone adjustments to individual sound files during playback, as well as modifications to call sequence structure, including but not limited to, order, timing, and inclusion of calls;
(c) a speaker system for outputting said sound files;
and a control interface, integrated within the unit or optionally located in a separate remote-control device, configured to initiate playback of sound files or sequences via physical or on-screen buttons.

2. The system of claim 1, wherein the variation engine comprises an artificial intelligence model trained to optimize sound and sequence variation based on species behavior data or user-defined profiles.

3. The system of claim 1, wherein said variations are dynamically selected per playback instance according to a constrained or weighted rule set, to reduce repetitiveness while maintaining biological realism.

4. The system of claim 1, wherein said variation engine includes but not limited to:
a pitch modulator;
a time stretcher;
an EQ profile selector;
and a volume envelope shaper.

5. The system of claim 1, further comprising a sequence variation engine configured to modify, including but not limited to, the order, timing, inclusion, or substitution of individual calls within a call sequence, based on rule-based or AI-driven logic to maintain naturalistic variability and prevent pattern habituation.

6. The system of claim 1, wherein the remote or on-unit control interface includes a plurality of buttons, each mapped to a distinct call or call sequence or other control or setting functions.

7. The system of claim 1, wherein both call sequence variation and per-call variation are implemented using at least one artificial intelligence engine.

8. The system of claim 1, further comprising a randomization engine configured to introduce probabilistic variation in sound-level parameters and/or sequence order during playback.”

9. A method of playing wildlife calls for attracting animals, comprising:
receiving a playback request from a remote or on-unit control device;
selecting a base wildlife call or call sequence;
applying variation to the selected call or call sequence prior to or during playback;
outputting the varied sound and or sound sequence through a speaker system;
wherein the variation emulates realistic vocal differences to reduce habituation in target animals.

10. A non-transitory machine-readable medium containing instructions that, when executed by a processor, cause a device to:
access a library of wildlife call files;
receive user input from a physical interface;
apply sound or sound sequence variation transformations prior to or during playback;
and emit wildlife sounds with realistic diversity.
